(19) United States
(12) Patent Application Publication
(10) Pub. No.: US 2026/0113342 A1
(43) Pub. Date: Apr. 23, 2026

(54) SYSTEMS AND METHODS FOR MANAGING COMPROMISED DATA PROCESSING SYSTEMS USING OUT OF BAND COMPONENTS

(71) Applicant: Dell Products L.P., Round Rock, TX (US)

(72) Inventors: LUIS ANTONIO VALENCIA REYES, Waxahachie, TX (US); VINODKUMAR VASUDEV OTTAR, McKinney, TX (US); ABEYE TESHOME, Austin, TX (US); RICHARD M. TONRY, Georgetown, TX (US); BASSEM EL-AZZAMI, Austin, TX (US); MOHIT ARORA, Frisco, TX (US); ADOLFO SANDOR MONTERO, Pflugerville, TX (US); RAJARAVI CHANDRA KOLLARAPU, Allen, TX (US)

(21) Appl. No.: 18/919,954

(22) Filed: Oct. 18, 2024

(51) Int. Cl. H04L 9/40

(52) U.S. Cl. CPC H04L 63/1425

(57) ABSTRACT

Methods and systems for managing operation of a data processing system are disclosed. To manage operation of the data processing system, anomalous activity originating from hardware resources of the data processing system may be detected. Based on the detection, policies for managing the operation of the hardware resources may be identified by a management system and provided to a management controller of the data processing system for implementation. By doing so, the operation of the data processing system may be updated to decrease the ability of the hardware resources to operate in an undesired manner.

### FIELD

Embodiments disclosed herein relate generally to managing a data processing system. More particularly, embodiments disclosed herein relate to systems and methods for managing operations of hardware resources of data processing systems.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1A shows a block diagram illustrating a system in accordance with an embodiment.

FIG. 1B shows a block diagram illustrating a data processing system in accordance with an embodiment.

FIGS. 2A-2B show interaction diagrams in accordance with an embodiment.

FIG. 3 shows a flow diagram illustrating a method of managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing (operation of) data processing systems. The data processing systems may provide computer implemented services to users of the data processing systems. The computer implemented services may include any quantity and type of such services. To provide the computer implemented services, data processing systems may include any number of hardware components (e.g., processors, memory modules, storage devices, communication device, etc.). The hardware components may support execution of any number and types of application (e.g., software components).

To provide the computer implemented services, the data processing system may establish secure communication sessions with various devices in order to allow the data processing system to transmit, obtain, and/or otherwise manage data, for example, stored by the various devices. For example, an external server may host files (e.g., containing sensitive data) and the data processing system may establish a communication session with the external server in order to obtain a copy of the files and/or a portion of the files.

However, the data processing system may be subject to undesired use if the data processing system is compromised by a malicious entity. For example, an unauthorized user may gain access to credentials (e.g., stored in hardware resources of the data processing system) and use the credentials to perform malicious activities that may negatively impact the data processing system and/or data security. For example, impacts of unauthorized operation of the data processing system may include reduced data security and/or increased likelihood of interruptions to desired computer implemented services provided by the data processing system.

To reduce impacts of undesired use of the data processing system and/or of unauthorized access to sensitive data (e.g., stored in external devices), a security management workflow may be implemented by a management system that is connected to various external devices and/or data processing systems via wireless networks. The management system may identify unusual activities (e.g., abnormal requests for data) based on, for example, user profiles stored in resources (e.g., memory, registers, storage, etc.) hosted by the management system. The unusual activities may include, for example, anomalous network traffic received from the data processing system by a remote entity (e.g., endpoint server).

In order to decrease the likelihood of unauthorized access to and/or unrestricted operation of data processing systems, management system may implement policies for the data processing system. The policies for the data processing system may be established and enforced using out-of-band components that verifies operations (e.g., of the data processing system) to be in compliance with the corresponding policies and implements restrictions of operation based on the policies. By doing so, managing restrictions on operations of data processing systems may be implemented without utilizing an operating system of the data processing system and/or in the event that the in-band components of the data processing system are not functional (e.g., powered off, lacking network connection, etc.) and/or are compromised (e.g., by a malicious entity).

By utilizing out-of-band components of the data processing system, authorized modifications (e.g., restrictions, limitations, etc.) to operations of hardware components of the data processing system may be managed remotely (e.g., from a device with a different geographic location from the data processing system) and the likelihood of unauthorized access to and/or operations of the data processing system may be decreased while facilitating implementation of restrictions for operation of the data processing system.

By doing so, embodiments disclosed herein may provide a system for managing (operation of) a data processing system based on identification of anomalous behavior originating by hardware resources of the data processing system. Based on the identification of anomalous behavior, a management system may provide instructions, using out-of-band methods, for modifying operation of the hardware resources, and/or any other components of the data processing system. The modifications to the operation of the hardware resources and/or other components of the data processing system may be implemented in a seamless manner by a management controller of the data processing system. Thereby, decreasing the likelihood of unauthorized access to and/or operation of the data processing system, reducing an ability of the hardware resources to operate in an undesired manner, and increasing the likelihood of seamlessly implementing modifications to operations of the data processing system. Once the operations of the data processing system are updated based on the identified anomalous behavior, a likelihood that the updated data processing system may provide more desirable computer implemented services may be increased.

In an embodiment, a method for managing operation of a data processing system is provided. The method may include: obtaining, by a management controller and using an out-of-band communication channel, a message from a management system, the message indicating that hardware resources of the data processing system are operating in an undesired manner, and that at least one action is to be performed to reduce an impact of the undesired manner of operation of the hardware resources on at least one remote entity; initiating, by the management controller, updating of operation of the data processing system using the at least one action, the updated operation of the data processing system reducing an ability of the hardware resources to operate in the undesired manner; and providing computer implemented services to a user of the data processing system while the updated operation of the data processing system is enforced by the management controller and the remote entity is used, at least in part, in the providing of the computer implemented services.

Initiating the updating may include: programming a network module of the data processing system to drop network traffic originating from the hardware resources.

Initiating the update may also include: programming a network module of the data processing system to drop first network traffic originating from the hardware resources and second network traffic destinated for the hardware resources.

Initiating the update may also include: modifying operation of the hardware resources to limit network traffic originated by the hardware resources.

Modifying the operation may include depowering at least a portion of the hardware resources.

Modifying the operation may also include terminating execution of at least one application hosted by the hardware resources.

The remote entity may provide a second computer implemented services used by the hardware resources in providing the computer implemented services.

The message may be based, at least in part, on a notification by the remote entity indicating that network traffic originated by the hardware resources appears to be malicious in nature.

The message may be based, at least in part, on a notification by the remote entity indicating that network traffic originated by the hardware resources is anomalous.

The data processing system may include a network module adapted to separately advertise network endpoints for the management controller and hardware resources of the data processing system, the network endpoints being usable by a server to address communications to the hardware resources using an in-band communication channel and the management controller using the out-of-band communication channel.

The management controller and the network module may be on separate power domains from the hardware resources so that the management controller and the network module may be operable while the hardware resources are inoperable.

The out-of-band communication channel may run through the network module, and the in-band communication channel that services the hardware resources may also run through the network module.

The network module may host a transmission control protocol/internet protocol (TCP/IP) stack to facilitate network communications via the out-of-band communication channel.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

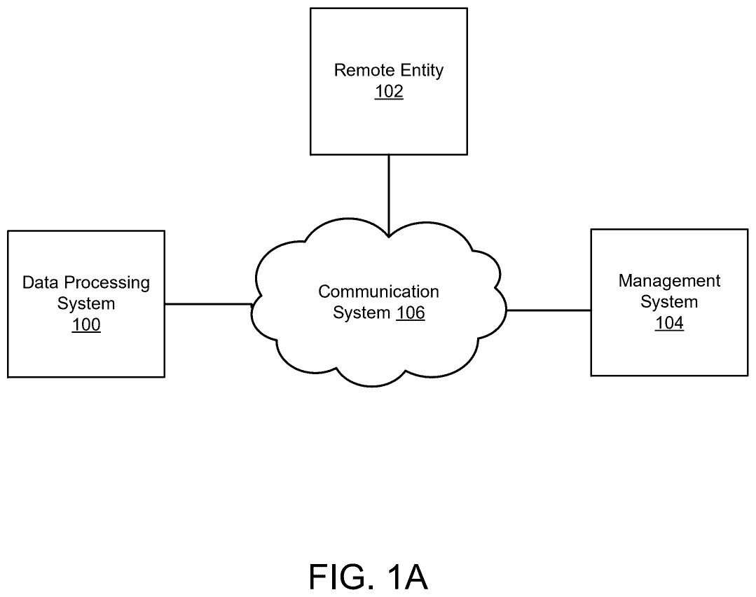

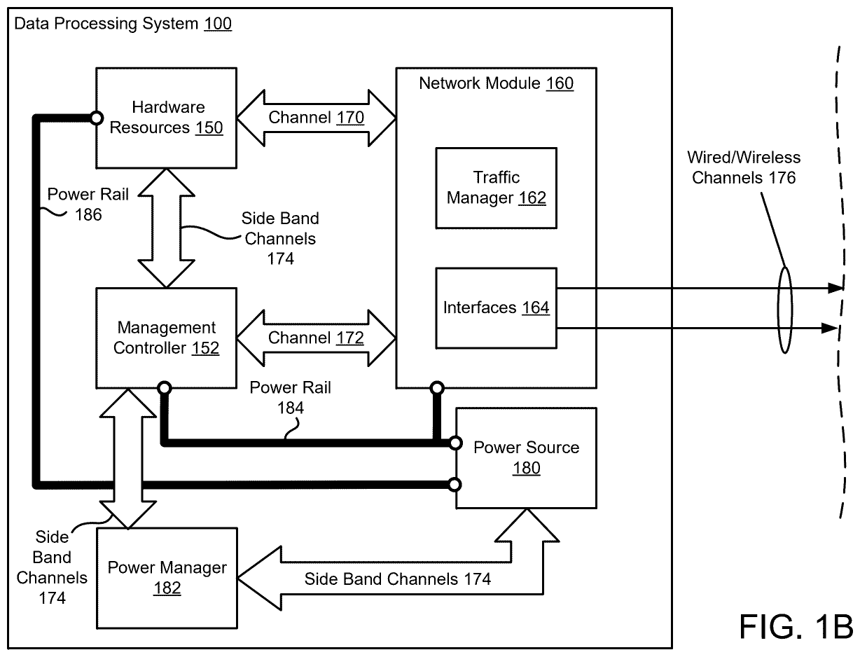

Turning to FIG. 1A, a block diagram illustrating a system in accordance with an embodiment is shown. The system shown in FIG. 1A may provide for management of data processing systems that may provide, at least in part, computer-implemented services. The system may include any number of data processing system 100 (e.g., computing devices) that may each include any number of hardware components (e.g., processors, memory modules, storage devices, communications devices). The hardware components may support execution of any number and types of applications (e.g., software components). Changes in available functionalities of the hardware and/or software components may provide for various types of different computer-implemented services to be provided over time. Refer to FIG. 1B for additional details regarding data processing system 100.

To facilitate the computer implemented services, the system may include remote entity 102. Remote entity 102 may include any number of remote entities. Remote entity 102 may provide data management services, communication services, and may be remote to devices operably connected to remote entity 102 (to which computer implemented services may be provided). The data management services may include storing data and providing access to previously stored data.

To utilize the data management services provided by remote entity 102, a secure communication session may be established between data processing system 100 and remote entity 102. By establishing a secure communication session, network traffic including both upstream communications (e.g., outbound communications to remote entity 102 from data processing system 100) and downstream communications (e.g., inbound communications received from remote entity 102 to data processing system 100) between data processing system 100 and remote entity 102 may be facilitated. For example, data processing system 100 may utilize the secure communication session to provide a request for portion of data stored by remote entity 102 and in response, remote entity 102 may identify and provide (e.g., transmit) data responsive to the request to data processing system 100.

Operation of and/or computer implemented services provided by a data processing system (e.g., data processing system 100) may be negatively impacted if any unauthorized modifications (e.g., to hardware and/or software components of the data processing system, to sensitive data stored by the data processing system, etc.) occur. For example, a malicious entity may gain unauthorized access to and/or control of (operations of) the data processing system 100 after a secure communication session has been established with remote entity 102 and initiate network traffic to remote entity 102, resulting in malicious activity such as unauthorized data copying or abnormal communications.

To identify malicious activity and/or unauthorized access to sensitive data, remote entity 102 may utilize profiles for each device (for which a secure communication session has been established) and monitor activity (e.g., network traffic) of the devices to identify anomalous behavior. If anomalous behavior (e.g., abnormal activity) for a device (e.g., data processing system 100) is detected, remote entity 102 may block communications from the device and/or user associated with the device. For example, remote entity 102 may terminate the communication session (e.g., at least one end of the communication session) based on the credentials associated with data processing system 100 and/or the user of the data processing system and reject any communications from data processing system 100.

However, even if the communication session is restricted on one end (e.g., the end of the remote entity) after identification of anomalous behavior, outbound communications from data processing system 100 may still be provided to remote entity 102 and/or any other remote entities with established communication sessions with data processing system 100. For example, network traffic from data processing system 100 may be received by remote entity 102 (even after termination of the remote entity's end of the communication session) and remote entity 102 may reject the network traffic after analyzing and/or verifying termination of communication with data processing system 100 (e.g., checking a list of devices that are blacklisted (banned devices) using the credentials of data processing system 100).

In addition, terminating one end of the communication session (e.g., remote entity end of the communication session) may not disable outbound communications to other remote entities from data processing system 100. For example, data processing system 100 may continue to communicate with other remote entities as an alternative to obtain sensitive data stored by the remote entities.

In general, embodiments disclosed herein may provide methods, systems, and/or devices for managing operation of a data processing system. To manage operation of the data processing system, a system in accordance with an embodiment may utilize out-of-band components of data processing system to implement an action set to update operation of the hardware resources (and/or other components) of the data processing system. The data processing system may include a management controller that may communicate with other devices and/or the hardware resources without traversing in-band communication channels and without utilizing in-band components. For example, the management controller may monitor operations of the data processing system to identify any occurrences of policy management events and based on identified occurrences of policy management events, identify modifications to operations of the discrete graphics component.

By doing so, restrictions on functionality of the hardware resources to operate may be implemented without utilizing in-band components of the data processing system, thereby decreasing the likelihood of potential issues implementing restrictions of the data processing system and/or increasing the likelihood of the data processing system providing desirable computer implemented services to a user in conformity with the limitations established by the polices.

Therefore, out-of-band components may be used to implement control policies for a data processing system (e.g., 100) to update operation of the hardware resources of data processing system 100. To do so, an occurrence of a policy management event may be identified and a desired state for the discrete graphics component may be identified based on the control policy corresponding to the policy management event.

The identified policy management event may be utilized by the out-of-band components to determine which of the control policies (of a set of control policies) for the data processing system to implement. The set of control policies may specify an outcome and/or action sets to be performed to update operation of the discrete graphics component of the data processing system. By updating operation of the discrete graphics component (using the out-of-band components of data processing system 100), computer implemented services that conform to limits specified by the set of control policies may be provided.

To perform the above-mentioned functionality, the system of FIG. 1A may include data processing system 100, remote entity 102, and/or management system 104. Data processing system 100, remote entity 102, and/or management system 104, and/or any other type of devices not shown in FIG. 1A may perform all, or a portion of the computer-implemented services independently and/or cooperatively. Each of these components is discussed below.

Data processing system 100 may include any number and/or type of data processing systems (e.g., other data processing systems, management systems, storage devices, user devices, etc.) that may provide computer implemented services to users of data processing system 100 and/or other computing devices operably connected to data processing system 100.

To facilitate the computer implemented services, data processing system 100 may participate in operation management services provided in cooperation with management system 104. To participate in the operation management services, data processing system 100 may include out-of-band components (e.g., network module, management controller, etc.) and functionality that may allow data exchange between the out-of-band components independently from in-band components of data processing system 100. For more information regarding out-of-band components of data processing system 100, refer to the discussion of FIG. 1B.

For example, the out-of-band components of data processing system 100 may (i) obtain communications (e.g., messages) from management system 104, (ii) initiate updates to operation of the data processing system, (iii) provide enforce the updated operation of the data processing system when providing computer implemented services to a user of the data processing system, and/or (iv) perform other actions to reduce an ability of data processing system (e.g., hardware resources and/or other components of data processing system 100) to operate in an undesired manner. The out-of-band components may initiate updates to operation of data processing system 100 based at least in part on obtaining messages (e.g., from management system 104) indicating (i) that hardware resources of data processing system 100 are operating in an undesired manner and (ii) that at least one action is to be performed to reduce an impact of the undesired manner of operation of the hardware resources on at least one remote entity.

Management system 104 may also participate in the device management services. Management system 104 may include any number and/or type of management systems. To perform its functionality, management system 104 may participate in the device management services provided in cooperation with data processing system 100 and/or remote entity 102.

When participating in the device management services, management system 104 may (i) obtain communications from remote entities (e.g., remote entity 102) indicating detection of anomalous behavior from data processing system 100, (ii) identify an applicable policy to update operation of the data processing system based on the level of concern associated with the anomalous behavior, (iii) provide a message include the applicable policy to data processing system 100 using out-of-band methods, and/or (iv) perform any other process to facilitate device management services.

Remote entity 102 may include any number and/or type of remote entities that may participate in providing computer implemented services. Remote entity 102 may store and manage device profiles (e.g., including any credentials associated with a device and/or user of the device) and/or other information related to devices authorized to establish secure communication sessions for data processing system 100. To perform its functionality, remote entity 102 may communicate (e.g., exchange data) with the out-of-band components of data processing system 100 using out-of-band communication channels. For example, remote entity 102 may provide and/or receive communications for data processing system 100 via a management controller of data processing system 100 (e.g., bypassing any in-band components of data processing system 100).

To facilitate device management services, remote entity 102 may, for example, (i) receive network traffic from data processing system 100, (ii) identify anomalous behavior of data processing system 100 based on the network traffic, (iii) request to modify (e.g., restrict, limit, etc.) communications of data processing system 100 (and/or components of data processing system to management system 104, and/or (iv) perform other actions that may facilitate device management services.

Thus, the operation of data processing system 100 may be managed according to access control policies implemented based on identification of anomalous behavior originating by hardware resources of the data processing system. Based on the identification of anomalous behavior, a management system may provide instructions, using out-of-band methods, indicating modifications of operation of the hardware resources. The modifications of the operation of the hardware resources may be implemented in a seamless manner by a management controller of the data processing system. Thereby, decreasing the likelihood of unauthorized access to and/or operation of the data processing system, reducing an ability of the hardware resources to operate in an undesired manner, and increasing the likelihood of seamlessly implementing modifications to operations of the data processing system. Once the operations of the data processing system are updated based on the identified anomalous behavior, a likelihood that the updated data processing system may provide more desirable computer implemented services may be increased.

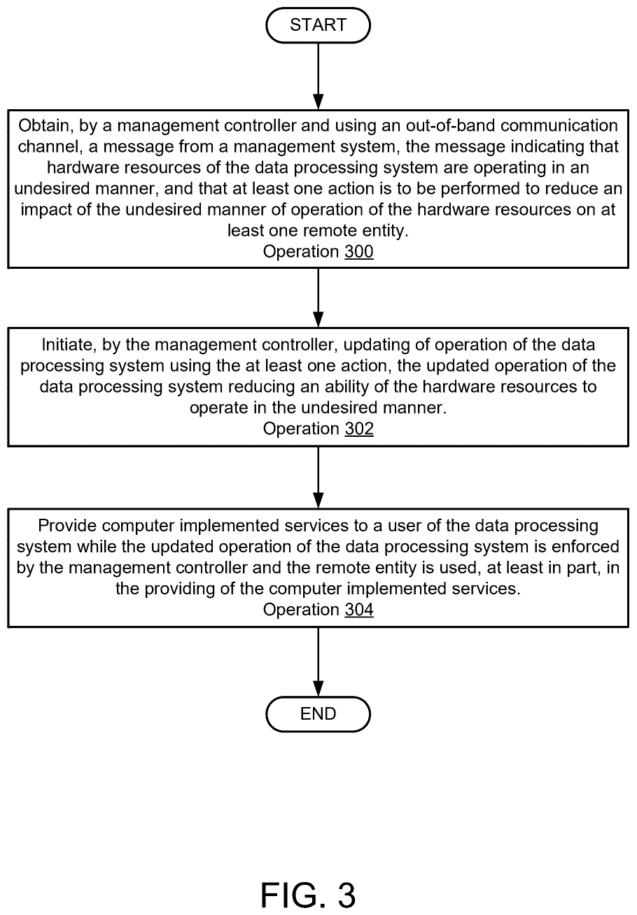

When providing their functionality, data processing system 100, remote entity 102, and/or management system 104 may perform all, or a portion of the methods shown in FIG. 3.

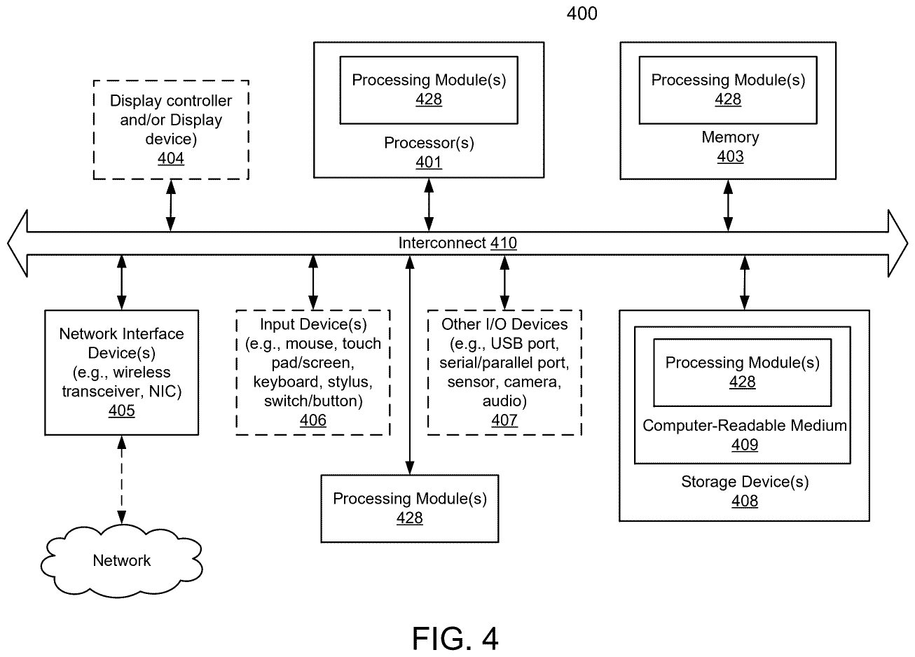

Any of (and/or components thereof) data processing system 100, remote entity 102, and/or management system 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

In an embodiment, one or more of data processing system 100, remote entity 102, and/or management system 104 are implemented using an internet of things (IoT) device, which may include a computing device. The IoT device may operate in accordance with a communication model and/or management model known to data processing system 100, remote entity 102, and/or management system 104, and/or other devices.

Any of the components illustrated in FIG. 1A may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and/or types of communication protocols (e.g., such as the internet protocol). Communication system 106 may include any number of in-band communication channel and/or out-of-band communication channels.

While illustrated in FIG. 1A as including a limited number of specific components, a system in accordance with an embodiment may include fewer, additional, and/or different components than those illustrated therein. For example, while the system of FIG. 1A shows a single data processing system (e.g., 100), it will be appreciated that the system may include any number of data processing systems.

Turning to FIG. 1B, a diagram illustrating data processing system 100 in accordance with an embodiment is shown. Data processing system 100 may be similar to any of data processing systems 100 shown in FIG. 1A.

To provide computer-implemented services, data processing system 100 may include any quantity of hardware resources 150. Hardware resources 150 may be in-band hardware components, and may include a processor operably coupled to memory, storage, and/or other hardware components. Hardware resources 150 may (e.g., via the processor) provide the computer-implemented services desired by users of data processing system 100.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing the hardware resources 150 to communicate with other devices via packet switched networks and/or other types of communication networks.

The processor may also host various applications that provide the computer-implemented services. The applications may utilize various services provided by the management entities and use (at least indirectly) the network stack to communicate with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised. If the applications trust these communications, then the applications may also be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100) to another device via any number of intermediate networks (e.g., via wired/wireless channels 176 that are part of the networks).

To reduce the likelihood of the applications and/or other in-band entities from being indirectly compromised, data processing system 100 may include management controller 152 and network module 160. Each of these components of data processing system 100 is discussed below.

Management controller 152 may operate independently from hardware resources 150 and, therefore, hardware resources 150 may not host and/or manage operation of management controller 152. In addition, management controller 152 may be distinct from hardware resources 150 and, therefore, may be physically separate from hardware resources 150. Management controller 152 may also be operably connected to communication components of data processing system 100 via separate channels (e.g., 172) from the in-band components.

Management controller 152 may be implemented, for example, using a system on a chip or other type of independently operating computing device (e.g., independent from the in-band components, such as hardware resources 150, of a host data processing system 100). Management controller 152 may provide various management functionalities for data processing system 100. For example, management controller 152 may monitor various ongoing processes performed by the in-band component, may manage power distribution, thermal management, and/or other functions of data processing system 100.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, to reduce the likelihood of indirect compromise of an application hosted by hardware resources 150, management controller 152 may enable information from other devices to be provided to the application without traversing the network stack and/or management entities of hardware resources 150. To do so, the other devices may direct communications including the information to management controller 152. Management controller 152 may then, for example, send the information via side band channels 174 to hardware resources 150 (e.g., to store it in a memory location accessible by the application, such as a shared memory location, a mailbox architecture, or other type of memory-based communication system) to provide it to the application. Thus, the application may receive and act on the information without the information passing through potentially compromised entities. Consequently, the information may be less likely to also be compromised, thereby reducing the possibility of the application becoming indirectly compromised. Similar processes may be used to facilitate outbound communications from the applications.

Information provided to the application by management controller 152 may include, for example, instructions for implementation of computer-implemented services desired by users of data processing system 100.

To facilitate communication with other devices, data processing system 100 may include network module 160. Network module 160 may provide communication services for in-band components and out-of-band components (e.g., management controller 152) of data processing system 100.

To provide the above-described functionalities, network module 160 may include traffic manager 162, interfaces 164, and may host an instance of a TCP/IP stack to facilitate communication with other devices independently of any of the in-band components (e.g., does not rely on any hosted software, hardware components, etc.). Accordingly, compromise of any of hardware resources 150 and hosted component may not result in indirect compromise of network module 160, management controller 152, and entities hosted by management controller 152.

Management controller 152 may be operably connected to communication components of data processing system 100 via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

Traffic manager 162 may include functionality to (i) discriminate traffic directed to various network endpoints advertised by data processing system 100, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100 may appear to be two independent network entities, that may independently addressable, and otherwise unrelated to one another.

Network module 160 may utilize the instance of the TCP/IP stack to allow hardware resources 150 and/or management controller 152 to communicate with other devices via packet switched networks and/or other types of communication networks.

To facilitate management of data processing system 140 over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100 may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails (e.g., by providing instructions via side band channels 174). Management controller 152 may cooperate with power manager 182 to manage supply of power to these power domains. Management controller 152 may communicate with power manager 182 via side band channels 174 and/or via other means.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

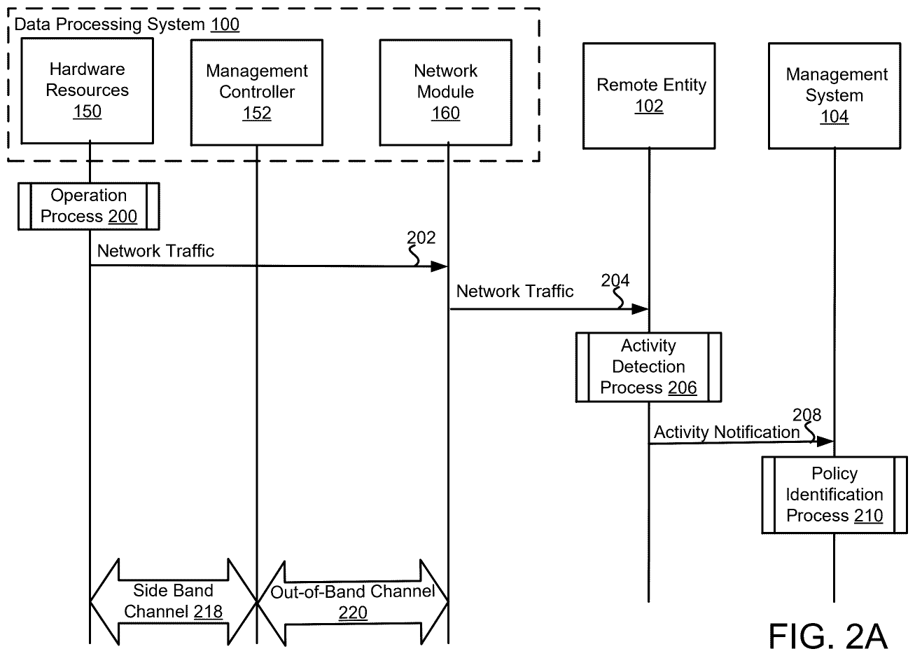

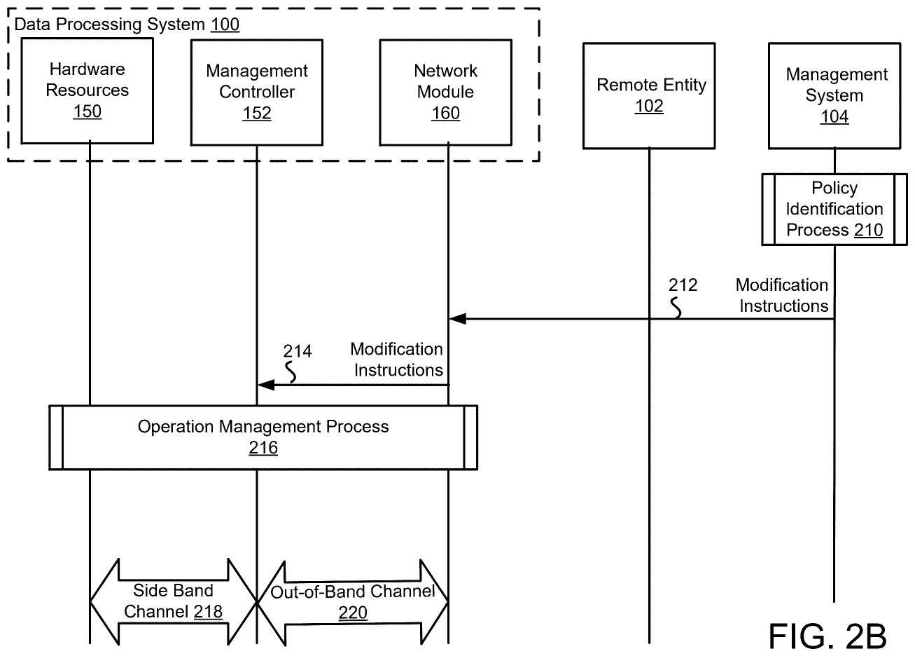

When providing its functionality, management controller 152 may perform all, or a portion, of the methods and operations described in FIGS. 2A-2B.

While illustrated in FIG. 1B with a limited number of specific components, a system may include additional, fewer, and/or different components without departing from embodiments disclosed herein.

To further clarify embodiments disclosed herein, interaction diagrams in accordance with an embodiment is shown in FIGS. 2A-2B. The interaction diagrams may illustrate examples of how data may be obtained and used within the systems of FIGS. 1A-1B.

In the interaction diagrams, processes performed by and interactions between components of a system in accordance with an embodiment are shown. In the diagrams, components of the system are illustrated using a first set of shapes (e.g., 150, 152, etc.), located towards the top of each figure. Lines descend from these shapes. Processes performed by the components of the system are illustrated using a second set of shapes (e.g., 200, 206) superimposed over these lines.

Interactions (e.g., communication, data transmissions, etc.) between the components of the system are illustrated using a third set of shapes (e.g., 202, 208, etc.) that extend between the lines. The third set of shapes may include lines terminating in one or two arrows. Lines terminating in a single arrow may indicate that one-way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 202 may occur prior to the interaction labeled as 204. However, it will be appreciated that the processes and interactions may be performed in different orders, any may be omitted, and other processes or interactions may be performed without departing from embodiments disclosed herein.

The processes shown in FIGS. 2A-2B may be performed by any entity shown in the systems of FIGS. 1A-1B (e.g., a device similar to one of data processing system 100, remote entity 102, management system 104, etc.) and/or another entity without departing from embodiments disclosed herein.

Turning to FIG. 2A, a first interaction diagram in accordance with an embodiment is shown. The first interaction diagram may illustrate processes and interactions that may occur during identification of anomalous behavior of a data processing system.

To identify anomalous behavior, operation process 200 may be performed to initiate operation of the data processing system (e.g., 100). During operation process 200, hardware resources 150 may receive input, for example, by a user operating data processing system 100 indicating initiation of operation of the hardware resources to perform activities, such as, communication services with external devices. The communications may include requests for data, request for performance of certain functions (e.g., storing data), etc. and may be direct to a remote device (e.g., remote entity 102).

At interaction 202, the network traffic may be provided to network module 160 by hardware resources 150. For example, the network traffic may be provided to network module 160 via transmitting the network traffic across a sideband channel to network module 160. The side band channel 214 may be similar to channel 170.

At interaction 204, the network traffic may be provided to remote entity 102 by network module 160. For example, the network traffic may be provided by network module 160 by: (i) identifying a network access point of a wireless network established for the destination of the network traffic (e.g., remote entity 102), (ii) provide data transmission services (e.g., in data packages compatible with the wireless communication channel, (iii) transmitting the network traffic across the wireless communication channel, and/or any other processes. By doing so, remote entity 102 may obtain the network traffic.

Once obtained, activity detection process 206 may be performed by remote entity 102 to screen the network traffic for anomalous activity. During activity detection process 206, the network traffic may be subjected to any type of screening processes performed by remote entity 102 (and/or components of remote entity 102). For example, to screen the network traffic, remote entity 102 may: (i) identify contents of the network traffic, (ii) monitor the type of communication directed to remote entity 102, (iii) prevent the network traffic from transmitting to the destination as requested, and/or any other actions. The contents and/or type of communication (or any other portion) of the network traffic may be identified as anomalous based on, for example, previous activities and/or behavior originating from hardware resources 150 of data processing system 100. As such, remote entity 102 may identify the activity (e.g., the network traffic) originating by hardware resources 150 as malicious in nature.

Once identified, at interaction 208, an activity notification may be generated and provided to management system 104 by remote entity 102. The activity notification may be provided to management system 104 via (i) transmission via a message, (ii) identification of the activity notification by management system 104, (iii) via a publish-subscribe system where management system 104 subscribes to updates from remote entity 102 thereby causing a copy of the activity notification to be propagated to management system 104, and/or via other processes. By providing the activity notification to management system 104, management system 104 may received a copy of the activity notification (e.g., detected activities of hardware resources 150).

Once received, policy identification process 210 may be performed to identify a policy corresponding to the activity detected by remote entity 102. During policy identification process 210, management system 104 may evaluate the activity of hardware resources and identify a policy to manage the activity. The policy may be identified by: (i) aggregating information regarding the activity of hardware resources 150 from multiple different devices (e.g., other remote entities), (ii) evaluate the degree of severity of the activity detected, (iii) based on the degree of severity, identify a policy applicable to the data processing system (e.g., 100), and/or any other any processes.

The policies may include instructions for performing different action sets with progressively higher restrictions on operations of the hardware resources (e.g., 150). Refer to FIG. 2B for additional details regarding implementation of policies for managing operation of data processing system 100.

Thus, as shown in the example of FIG. 2A, anomalous activity originating by hardware resources of a data processing system may be identified and managed according to a degree of severity of impact based on the anomalous activity. By doing so, compromised data processing systems may be identified prior to servicing requests initiated by a malicious entity.

Turning to FIG. 2B, a second interaction diagram in accordance with an embodiment is shown. The second interaction diagram may illustrate example processes and interactions that may occur during modifying operation of a data processing system.

To modify operation of the data processing system, management system 104 may perform policy identification process 210. As described above, policy identification process 210 may include identifying a policy applicable to managing malicious activity originating by hardware resources 150. The policy may be identified by (i) identifying the source of the activity (e.g., identifier for hardware resources 150), (ii) identifying the level of severity or confidence in the anomalous activity, and/or by any other processes. The policy may include instructions and/or commands for modifying operation of hardware resources (e.g., 150) of the data processing system based on, for example, the degree of severity of the anomalous activity.

For example, a first policy may be triggered when the severity or degree of confidence of the anomalous activity is low. The first policy may include instructions for modifying operations of data processing system 100 (and/or components of the data processing system) by limiting and/or restricting outbound communications originating from a network endpoint associated with hardware resources 150.

The policies may progressively increase restrictions and/or limitations on operation of hardware resources 150 as the level of severity and/or confidence of the anomalous activity increases. For example, a second policy may include instructions for modifying operations of data processing system 100 by disabling all communications originating from and/or directed to hardware resources 150 which may include all outbound and inbound communications for the network endpoint corresponding to the hardware resources. Therefore, inbound and out bound network traffic with respect to hardware resources 150 may cease.

As an additional example, a third policy may include instructions for modifying operations of data processing system 100 by initiating shut down all and/or a portion of operations of the hardware resources (and/or software resources hosted by the hardware resources) to disable all functionality of hardware resources 150. For example, the third policy may indicating the action to be performed includes shutting down operation of the in-band components (e.g., processor, memory module, etc.).

As a result of performing policy identification process 210, management system 104 may generate a data package including modification instructions to provide to data processing system 100 for implementation.

At interaction 212, the modification instructions may be generated and provided to network module 160 by management system 104. For example, the modification instructions may be provided to network module 160 via (i) packaging at least a copy of the modification instructions as a data package, (ii) transmitting the data package across a wireless communication channel to network module 160, and/or any other processes. By providing the modification instructions to network module 160, network module 160 may receive a copy of the modification instructions.

At interaction 214, the modification instructions may be provided to management controller 152 by network module 160 using an out-of-band communication channel (e.g., out-of-band channel 220). The out-of-band communication channel may be similar to the out-of-band channel 172 shown and described in FIG. 1B. For example, the modification instructions may be provided to management controller 152 via (i) identifying the destination of the modification instructions (e.g., management controller 152), (ii) identifying a network endpoint of the management controller, (iii) transmitting the modification instructions across an out-of-band communication channel to management controller 152, and/or any other processes. By providing the modification instructions to management controller 152, management controller 152 may receive a copy of the modification instructions and thereafter, provide management services as specified by the modification instructions.

To implement the modification instructions, operation management process 216 may be performed. During operation management process 216, management controller 152 may cooperatively perform an action set (e.g., specified by the modification instructions) with network module 160 and/or hardware resources 150 in order to initiate updating operation of data processing system 100. Initiating the updating of the operation of data processing system 100A may include: (i) programming a network module (hosted by the data processing system) to drop network traffic originating from hardware resources 150, (ii) programming the network module to drop all network traffic (e.g., originating from and/or destinated for) for hardware resources 150, (iii) modifying operation of hardware resources 150 to limit network traffic originated by the hardware resources, and/or (iv) performing any other processes to reduce the ability of hardware resources 150 to operate in the undesired manner.

To initiate updating operation of the data processing system, management controller 152 may (i) read the modification instructions to identify the action set to be performed, (ii) identify components (e.g., hardware resources 150, network module 160, and/or any other components of data processing system 100) to perform the action, (iii) generate instructions for the components to perform the action, (iv) provide the instructions to the corresponding components in order to implement the modifications, and/or any other processes. The instructions may be provided to the respective components by management controller 152 using a side band communication channel (e.g., side band channel 218). The side band communication channel may be similar to the side band channel 174 shown and described in FIG. 1B.

The instructions may include various action sets to be performed by hardware resources 150, network module 160, and/or any other components of data processing system 100 in order to modify the operation of the data processing system. For example, the instructions may specify access control actions including, at least in part, (i) depowering the hardware resources 150 (e.g., for a period of time specified by the modification instructions), (ii) disabling a portion of functionality of the hardware resources 150, (iii) blacklisting at least a portion of application hosted by the hardware resources 150 from invoking functionality of any components that may generate network traffic, and/or (iv) any other action sets.

Once received, hardware resources 150 and/or network module 160 may utilize the modification instructions to cooperatively perform operation management process 214. During operation management process 214, updates and/or modifications (as specified by the modification instructions) to operations of hardware resources 150, network module 160, and/or any other components of data processing system 100A may be implemented.

For example, network module 160 may receive the instructions indicating restricting all network traffic originating from the network endpoint associated with hardware resources and may update functionality of the traffic manager (e.g., similar to traffic manager 162 shown and described above in FIG. 1B) hosted by network module. As such, when network traffic is received by network module 160, the traffic manager may discriminate traffic originated by hardware resources 150 and block the network traffic from being provided to the network endpoint of the intended entity (e.g., remote entity 102).

As a result of operation management process 216, data processing system 100 may enter a new operating state to process data in a manner in accordance with the applicable policies. Updating operation of data processing system 100 may reduce the impact of the undesired manner of operation of the hardware resources on the remote entity (e.g., external entity being used by the data processing system to provide the computer implemented services). By updating operation of data processing system 100, the potential negative impact of malicious activity initiated with remote entity 102 by data processing system 100 may be mitigated without utilizing computer resources of remote entity 102. For example, computing resources of remote entity 102 usable to screen, blacklist, and/or otherwise manage incoming communications from external devices, such as data processing system 100, may remain available to perform other processes to provide computer implemented services with external devices.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2B may perform various methods to improve secure operations of a data processing system based on detection of anomalous activity by the data processing system using out-of-band methods. By doing so, an out-of-band component of the data processing system may be able to obtain and/or enforce policies corresponding to the potential impact of the anomalous activity on operation of the data processing system and thereby, may decrease the likelihood of unauthorized access and/or operation of the data processing systems.

FIG. 3 illustrates a method that may be performed by the components of the system of FIGS. 1A-2B. In the diagram discussed below and shown in FIG. 3, any of the operations may be repeated, performed in different orders, and/or performed in parallel with or in a partially overlapping in a timely manner with other operations. The method described with respect to FIG. 3 may be performed by a data processing system and/or another device.

Turning to FIG. 3, a flow diagram illustrating a method of managing a data processing system in accordance with an embodiment is shown. The method may be performed, for example, by a data processing system, a management system, a communication system, a management controller, hardware resources, and/or other components illustrated in FIGS. 1A-2B.

Prior to operation 300, activity (e.g., network traffic) originating from hardware resources of a data processing system may be screened to identify undesired manner of operations of the hardware resources (e.g., malicious activity). The activity may be received by a remote entity and analyzed to determine whether the activity is anomalous based on previous activity originating from the hardware resources.

If anomalous behavior is detected, the remote entity may generate and provide a notification to a management system indicating the activity (e.g., network traffic) originated by the hardware resources is anomalous, appears to be malicious in nature, and/or is undesirable. Once received, the management system may identify an applicable policy for managing operation of the data processing system based on, at least in part, a level of confidence and/or degree of severity of the undesired manner of operation of the hardware resources. The identified applicable policy may include instructions to perform an action to modify operation of the data processing system (and/or components of the data processing system).

At operation 300, a message from a management system may be obtained by a management controller and using an out-of-band communication channel. The message may indicate that hardware resources of the data processing system are operating in an undesired manner, and that at least one action is to be performed to reduce an impact of the undesired manner of operation of the hardware resources on at least one remote entity.

The message may be obtained by (i) receiving the message from an external entity (e.g., management system), (ii) reading the message from storage (e.g., storage resources of the management controller), and/or by any other methods.

At operation 302, updating of operation of the data processing system may be initiated by the management controller using the at least one action. The updated operation of the data processing system reducing an ability of the hardware resources to operate in the undesired manner. Updating the operation of the data processing system may be initiated by (i) reading, by the management controller, the message to identify the at least one action to perform, (ii) generating, by the management controller, instructions for the components (e.g., hardware resources, network module, etc.) responsible for performing the at least one action, and/or any other methods.

Initiating the updating of the operation of the data processing system may include: (i) programming a network module of the data processing system to drop network traffic originating from the hardware resources, (ii) programming a network module of the data processing system to drop first network traffic originating from the hardware resources and second network traffic destinated for the hardware resources, (iii) modifying operation of the hardware resources to limit network traffic originated by the hardware resources, and/or (iv) any other methods.

Programming the network module of the data processing system to drop network traffic originating from the hardware resources may be facilitated by (i) communicating, by the management controller and using the out-of-band communication channel, instructions to restrict network traffic received from a network endpoint associated with the hardware resources (e.g., outbound communications), (ii) implementing, by the network module, the instructions by updating performance of a traffic manager hosted by the network module to discriminate and block the network traffic received from the network endpoint associated with the hardware resources, and/or by any other methods.

Programming the network module of the data processing system to drop the first network traffic and the second network traffic may be facilitated by (i) providing, by the management controller and using the out-of-band communication channel, instructions to the network module to restrict the traffic to/from the hardware resources (e.g., outbound and inbound communication), (ii) implementing, by the network module, the instructions by updating performance of the traffic manager (hosted by the network module) to discriminate and block the network traffic received from the network endpoint associated with the hardware resources (e.g., block the first network traffic) and/or directed to the network endpoint the network endpoint associated with the hardware resources(e.g., block the second network traffic), and/or by any other methods.

Modifying operation of the hardware resources to limit network traffic originated by the hardware resources may be facilitated by (i) providing, by the management controller and using the side band communication channel, instructions to the hardware resources to restrict functionality of, at least a portion, of the hardware resources, (ii) providing, by the management controller and using the side band communication channel, instructions to the hardware resources to shutdown (at least temporarily), and/or by any other methods.

At operation 304, computer implemented services may be provided to a user of the data processing system while the updated operation of the data processing system is enforced by the management controller and the remote entity is used, at least in part, in the providing of the computer implemented services. The computer implemented services may be provided by, for example, dropping traffic generated by and/or directed to the hardware resources while program code is executed, by stopping all traffic (e.g., network) flow to the hardware resources while the program code is executed, and/or otherwise ensuring that the previous modifications made to the data processing system continue while the computer implemented services are provided (e.g., via program execution).

The method may end following operation 304.

Using the methods illustrated in FIG. 3, embodiments disclosed herein may provide systems and methods usable to manage operation of a data processing system using out-of-band methods to perform action set when hardware resources of the data processing system are operating in an undesired manner. By performing the action set using out-of-band components of the data processing system, operation of the data processing system (and/or components thereof) may be updated to reduce an ability of the hardware resources to operate in the undesired manner.

Any of the components illustrated in FIGS. 1A-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
obtaining, by a management controller and using an out-of-band communication channel, a message from a management system, the message indicating that hardware resources of the data processing system are operating in an undesired manner, and that at least one action is to be performed to reduce an impact of the undesired manner of operation of the hardware resources on at least one remote entity;
initiating, by the management controller, updating of operation of the data processing system using the at least one action, the updated operation of the data processing system reducing an ability of the hardware resources to operate in the undesired manner; and
providing computer implemented services to a user of the data processing system while the updated operation of the data processing system is enforced by the management controller and the at least one remote entity is used, at least in part, in the providing of the computer implemented services.

2. The method of claim 1, wherein initiating the updating comprises:
programming a network module of the data processing system to drop network traffic originating from the hardware resources.

3. The method of claim 1, wherein initiating the updating comprises:
programming a network module of the data processing system to drop first network traffic originating from the hardware resources and second network traffic destinated for the hardware resources.

4. The method of claim 1, wherein initiating the updating comprises:
modifying operation of the hardware resources to limit network traffic originated by the hardware resources.

5. The method of claim 4, wherein modifying the operation comprises depowering at least a portion of the hardware resources.

6. The method of claim 4, wherein modifying the operation comprises terminating execution of at least one application hosted by the hardware resources.

7. The method of claim 1, wherein the at least one remote entity provides a second computer implemented services used by the hardware resources in providing the computer implemented services.

8. The method of claim 1, wherein the message is based, at least in part, on a notification by the at least one remote entity indicating that network traffic originated by the hardware resources appears to be malicious in nature.

9. The method of claim 1, wherein the message is based, at least in part, on a notification by the at least one remote entity indicating that network traffic originated by the hardware resources is anomalous.

10. The method of claim 1, wherein the data processing system comprises a network module adapted to separately advertise network endpoints for the management controller and the hardware resources of the data processing system, the network endpoints being usable by the at least one remote entity to address communications to the hardware resources using an in-band communication channel and the management controller using the out-of-band communication channel.

11. The method of claim 10, wherein the management controller and the network module are on separate power domains from the hardware resources so that the management controller and the network module are operable while the hardware resources are inoperable.

12. The method of claim 10, wherein the out-of-band communication channel runs through the network module, and the in-band communication channel that services the hardware resources also runs through the network module.

13. The method of claim 10, wherein the network module hosts a transmission control protocol/internet protocol (TCP/IP) stack to facilitate network communications via the out-of-band communication channel.

14. A non-transitory machine-readable medium having instructions stored therein, which when executed by a processor, cause the processor to perform operations for managing operation of a data processing system, the operations comprising:
obtaining, by a management controller and using an out-of-band communication channel, a message from a management system, the message indicating that hardware resources of the data processing system are operating in an undesired manner, and that at least one action is to be performed to reduce an impact of the undesired manner of operation of the hardware resources on at least one remote entity;
initiating, by the management controller, updating of operation of the data processing system using the at least one action, the updated operation of the data processing system reducing an ability of the hardware resources to operate in the undesired manner; and
providing computer implemented services to a user of the data processing system while the updated operation of the data processing system is enforced by the management controller and the at least one remote entity is used, at least in part, in the providing of the computer implemented services.

15. The non-transitory machine-readable medium of claim 14, wherein initiating the updating comprises:
programming a network module of the data processing system to drop network traffic originating from the hardware resources.

16. The non-transitory machine-readable medium of claim 14, wherein initiating the updating comprises:
programming a network module of the data processing system to drop first network traffic originating from the hardware resources and second network traffic destinated for the hardware resources.

17. The non-transitory machine-readable medium of claim 14, wherein initiating the updating comprises:
modifying operation of the hardware resources to limit network traffic originated by the hardware resources.

18. A data processing system, comprising:
a processor; and
a memory coupled to the processor to store instructions, which when executed by the processor, cause the processor to perform operations for managing operation of the data processing system, the operations comprising:
obtaining, by a management controller and using an out-of-band communication channel, a message from a management system, the message indicating that hardware resources of the data processing system are operating in an undesired manner, and that at least one action is to be performed to reduce an impact of the undesired manner of operation of the hardware resources on at least one remote entity;
initiating, by the management controller, updating of operation of the data processing system using the at least one action, the updated operation of the data processing system reducing an ability of the hardware resources to operate in the undesired manner; and
providing computer implemented services to a user of the data processing system while the updated operation of the data processing system is enforced by the management controller and the at least one remote entity is used, at least in part, in the providing of the computer implemented services.

19. The data processing system of claim 18, wherein initiating the updating comprises:
programming a network module of the data processing system to drop network traffic originating from the hardware resources.

20. The data processing system of claim 18, wherein initiating the updating comprises:
programming a network module of the data processing system to drop first network traffic originating from the hardware resources and second network traffic destinated for the hardware resources.
